(19) United States
(12) Patent Application Publication
(10) Pub. No.: US 2012/0045999 A1
(43) Pub. Date: Feb. 23, 2012

(54) ADAPTIVE ARRAY ANTENNA DEVICE AND ANTENNA CONTROL METHOD

(76) Inventor: Takeshi Ono, Osaka (JP)

(21) Appl. No.: 13/266,264

(22) PCT Filed: Jan. 19, 2011
(86) PCT No.: PCT/JP2011/000244

§ 371 Date: Oct. 26, 2011

(30) Foreign Application Priority Data
Jan. 28, 2010 (JP) 2010-016460

(51) Int. Cl. H04B 17/00

(52) U.S. Cl. 455/67.16; 455/67.11

(57) ABSTRACT

An adaptive array antenna device (120) includes: a wireless transmission antenna unit (121) which wirelessly transmits content data to q partner device; a path information calculation unit (123) which calculates transmission path information for specifying radiation pattern with which the content data can be wirelessly transmitted to the partner device, before an instruction to transmit the content data to the partner device is issued; and a memory (124) in which the transmission path information calculated by the path information calculation unit (123) is stored. The wireless transmission antenna unit (121) starts transmitting the content data to the partner device using the radiation pattern specified by the transmission path information stored in the memory (124), when the instruction to transmit the content data to the partner device is issued.

### TECHNICAL FIELD

The present invention relates to an adaptive array antenna device having variable directivity which allows electrically switching a beam direction.

### BACKGROUND ART

High-speed wireless transmission is in demand with the advancement of wireless communication devices having higher speed and larger capacity. This makes it difficult to satisfy a desired carrier-to-noise power ratio (CNR). In view of the above, an adaptive array antenna has been in use which includes antenna elements and variable phase shifters and can adaptively change radiation pattern of the array antenna with higher gain, by changing a phase variable specified for each of the variable phase shifters.

FIG. 11 shows a configuration example of a conventional n-system adaptive array antenna device. In FIG. 11, a conventional n-system adaptive array antenna device 1000 includes: an antenna element 1001ₖ; a selector switch 1002ₖ; a power amplifier 1003ₖ; a low noise amplifier 1004ₖ; a transmission mixer 1005ₖ; a receiving mixer 1006ₖ; a transmission local oscillator 1007; a receiving local oscillator 1008; a transmission driver amplifier 1009ₖ; a receiving driver amplifier 1010ₖ; a transmission variable phase shifter 1011ₖ; a receiving variable phase shifter 1012ₖ; a phase control circuit 1013; an arithmetic processing circuit 1014; and a BB/IF circuit 1015. It is to be noted that K is an integer from 1 to n.

First, transmission data to be wirelessly transmitted is input into the BB/IF circuit 1015 that handles a baseband (BB) and an intermediate frequency (IF). The BB/IF circuit 1015 performs modulation processing and waveform shaping processing on the input transmission data. The transmission data output from the BB/IF circuit 1015 is converted into a wireless frequency using the transmission variable phase shifter 1011ₖ, the transmission driver amplifier 1009ₖ, and the transmission mixer 1005ₖ. The transmission data converted into the wireless frequency is amplified by the power amplifier 1003ₖ and emitted as a radio wave from an array antenna including plural antenna elements 1001ₖ, using the selector switch 1002ₖ.

On the other hand, a wireless signal received by the array antenna is amplified by the low noise amplifier 1004ₖ using the selector switch 1002ₖ, converted into an intermediate frequency by the receiving mixer 1006ₖ, subjected to a signal processing and a demodulation processing performed by the BB/IF circuit 1015, using the receiving driver amplifier 1010ₖ and the receiving variable phase shifter 1012ₖ, and then output as received data.

As described above, it is possible to change the radiation pattern of the array antenna by changing phase variables of the transmission variable phase shifters 1011ₖ in the n-system wireless circuit so as to cause a phase difference in the n-system circuit.

In the conventional adaptive array antenna device 1000, the arithmetic processing circuit 1014 and the phase control circuit 1013 determine the phase variable that is set in the variable phase shifter 1011ₖ such that radiation pattern suitable to wireless transmission is obtained to enhance communication performance with a communication partner. In addition, an optimization technique such as the method of steepest descent is used in order to efficiently determine the phase variable. Optimization calculation of the phase variable needs to be repeatedly carried out for an optimal beam formation, and thus calculation process takes time. In view of the above, a technique is employed by which calculation time is reduced by using, in receiving (transmission), the phase variable used in transmission (receiving) as it is.

Further, in Patent Literature 1, a technique is disclosed which extracts, based on information indicated by a transmission signal, arrival angle information of a radio wave transmitted from a communication partner, generates a pseudo received signal corresponding to each of antenna elements based on the extracted arrival angle, and controls a phase of a received signal applied to each of the antenna elements according to a certain adaptation algorithm using the pseudo received signals.

In addition, in Patent Literature 2, a technique is disclosed which determines a radio wave environment based on a received signal received by each of antenna elements and performs signal processing on the received signal based on the determined radio wave environment.

### CITATION LIST

### Patent Literature

[PTL 1]
Japanese Unexamined Patent Application Publication No. 10-145130
[PTL 2]
Japanese Unexamined Patent Application Publication No. 2001-94488

### SUMMARY OF INVENTION

### Technical Problem

However, some conventional adaptive array antenna devices start the optimization calculation of the phase variable after receiving an instruction to transmit data. This results in a problem that there is a significant time lug between the time when the instruction to transmit data is issued and the time when actually starting transmission of the data.

The present invention has been conceived in view of the above-described problem and has an object to provide an adaptive array antenna device which suppresses a communication delay as resulting from processing of determining the radiation pattern of an antenna.

### Solution to Problem

In order to solve the problem described above, the present invention has a feature as below.

An adaptive array antenna device according to an embodiment of the present invention wirelessly transmits content data to a partner device. To be specific, the adaptive array antenna device includes: a wireless transmission antenna unit configured to wirelessly transmit the content data to the partner device; a path information calculation unit configured to calculate transmission path information for specifying radiation pattern with which the content data can be wirelessly transmitted to the partner device, before an instruction to transmit the content data to the partner device is issued; and a memory in which the transmission path information calculated by the path information calculation unit is stored. The wireless transmission antenna unit is configured to start transmitting the content data to the partner device using the radiation pattern specified by the transmission path information stored in the memory, when the instruction to transmit the content data to the partner device is issued.

According to the configuration described above, it is possible to instantly determine the radiation pattern of a radio wave emitted from the wireless transmission antenna unit at the time when starting transmission of content data. As a result, it is possible to reduce the time lug between the time when the instruction to transmit content data is issued and the time when actually starting transmission of the content data.

In addition, the path information calculation unit may calculate items of the transmission path information in advance, and to store the calculated items of the transmission path information in the memory, and the wireless transmission antenna unit may select one of the items of the transmission path information stored in the memory, and transmit the content data to the partner device using the radiation pattern specified by the selected item of the transmission path information. This makes it possible to select radiation pattern which is the most suitable to a current radio wave transmission environment. As a result, the communication quality is further improved.

In addition, the path information calculation unit may calculate the items of the transmission path information which indicate transmission paths to the partner device substantially different from each other, and store the calculated items of the transmission path information in the memory. This makes it possible to select an item of transmission path information from items of the transmission path information each having different transmission path, according to a change in the radio wave transmission environment, and thus it is possible to minimize an interruption of wireless communication.

However, even when the transmission path information is switched according to a change in the radio wave transmission environment as described above, it is not possible to obtain an advantageous effect of improving the communication quality merely by a slight difference before and after the switching; that is, the transmission path is substantially the same. In view of the above, it is desirable that items of the transmission path information to be stored in the memory are calculated such that the transmission paths to the partner device are substantially different from one another. For example, it is desirable that the difference in directions of main beams is larger than at least a beam width. In addition, the adaptive array antenna device may further include a wireless receiving antenna unit configured to receive control data indicating a receipt state of the content data of the partner device. Furthermore, when the receipt state indicated by the control data received by the wireless receiving antenna unit falls below a predetermined threshold, the wireless transmission antenna unit may select an other one of the items of the transmission path information stored in the memory, and resume transmission of the content data to the partner device using radiation pattern specified by the other one of the items of the transmission path information which has been selected.

There is another problem that, when a surrounding radio wave transmission environment changes during data transmission, the phase variable obtained by optimization calculation is not necessarily suitable for communication, and thus a transmission path suitable for communication to the partner device needs to be searched for again. In wireless communication using a millimeter wave band, in particular, the communication can be interrupted in some cases due to a block caused a motion by a person. Calculating a phase variable through optimization calculation every time the communication is interrupted deteriorates a communication speed and disables ensuring of a desirable communication speed for a certain application that is used.

In view of the above, according to the above-described configuration, items of transmission path information are stored in the memory and a suitable item of transmission path information can be selected from the items of transmission path information according to a change in the radio wave transmission environment, and thus it is possible to minimize an interruption of wireless communication.

In addition, a large number of receiving antennas and wireless circuits are necessary for detecting a direction of the partner using a received signal. Furthermore, a selector switch for transmission and receiving is necessary for using the same antenna in both the transmission and receiving, and thus deterioration of signal isolation and signal loss become greater in a super high frequency band such as a millimeter wave. Thus, according to the above-described configuration, it is possible to omit the selector switch by separately forming a wireless transmission antenna unit and a wireless receiving antenna unit.

In addition, the path information calculation unit may calculate a new item of transmission path information that is different from any of the items of transmission path information stored in the memory, when selecting any of the items of the transmission path information stored in the memory does not cause the receipt state to be equal to or larger than the threshold, and the wireless transmission antenna unit may resume transmission of the content data to the partner device using radiation pattern specified by the new item of the transmission path information calculated by the path information calculation unit. This makes it possible to perform wireless communication even when an installation location is changed, for example.

In addition, a priority level of each of the items of the transmission path information may be stored in the memory, and the wireless transmission antenna unit may select the items of the transmission path information in a descending order of the priority level. As a result, the communication quality is further improved.

In addition, the wireless transmission antenna unit may include: antenna elements; and variable phase shifters each of which controls a phase of a radio wave emitted from a corresponding one of the antenna elements, and the path information calculation unit may calculate, as the transmission path information, phase variables each of which is set in a corresponding one of the variable phase shifters. However, the transmission path information is not limited to the phase variable, and it is possible to any information that can control the radiation pattern of an antenna.

As an example, the path information calculation unit may transmit test data to the partner device with each of the variable phase shifters having a corresponding one of the phase variables determined arbitrarily, calculate each of the phase variables of the variable phase shifters through a predetermined optimization calculation technique using, as a parameter, communication performance indicated in response data to the test data, and store the calculated phase variables in the memory.

As another example, the path information calculation unit may transmit test data to the partner device with each of the variable phase shifters having a corresponding one of the phase variables determined arbitrarily, and store the phase variables determined arbitrarily in the memory, when communication performance indicated in response data to the test data exceeds a predetermined threshold.

In addition, the wireless transmission antenna unit may wirelessly transmit the test data to the partner device using a first wireless communication path, and wirelessly transmit the content data to the partner device using a second wireless communication path which has a band wider than a band of the first wireless communication path and requires receiving sensitivity higher than receiving sensitivity of the first wireless communication path.

An adaptive array antenna device according to another embodiment of the present invention wirelessly receives content data from a partner device. To be specific, the adaptive array antenna device includes: a wireless receiving antenna unit configured to wirelessly receive the content data from the partner device; a path information calculation unit configured to calculate transmission path information for specifying radiation pattern with which the content data can be wirelessly received from the partner device, before an instruction to receive the content data transmitted from the partner device is issued; and a memory in which the transmission path information calculated by the path information calculation unit is stored. The wireless receiving antenna unit is configured to start receiving the content data transmitted from the partner device using the radiation pattern specified by the transmission path information stored in the memory, when the instruction to receive the content data transmitted from the partner device is issued.

According to the configuration described above, it is possible to instantly determine the radiation pattern of a radio wave received by the wireless receiving antenna unit at the time when starting receiving of content data. As a result, it is possible to reduce the time lug between the instruction to receive the content data and the start of actual receiving.

An antenna control method according to an embodiment of the present invention is a method for controlling an antenna of an adaptive array antenna device which wirelessly transmits content data to a partner device. The adaptive array antenna device includes a memory and a wireless transmission antenna unit for wirelessly transmitting the content data to the partner device. The antenna control method including: calculating transmission path information for specifying radiation pattern with which the content data can be wirelessly transmitted to the partner device and storing the transmission path information in the memory, before an instruction to transmit the content data to the partner device is issued; and causing the wireless transmission antenna unit to start transmitting the content data to the partner device using the radiation pattern specified by the transmission path information stored in the memory, when the instruction to transmit the content data to the partner device is issued.

An antenna control method according to another embodiment of the present invention is a method for controlling an antenna of an adaptive array antenna device which wirelessly receives content data from a partner device. The adaptive array antenna device includes a memory and a wireless receiving antenna unit for wirelessly receiving the content data from the partner device. The antenna control method includes: calculating transmission path information for specifying radiation pattern with which the content data can be wirelessly received from the partner device, before an instruction to receive the content data transmitted from the partner device is issued; and causing the wireless receiving antenna unit to start receiving the content data transmitted from the partner device using the radiation pattern specified by the transmission path information stored in the memory, when the instruction to receive the content data transmitted from the partner device is issued.

It is to be noted that the present invention can be implemented not only as an adaptive array antenna device and an antenna controlling method but also as a program for causing a computer to perform steps included in the antenna controlling method and a semiconductor integrated circuit (LSI) which implements part of functions of the adaptive array antenna device. Furthermore, such a program can be distributed via a non-transitory computer-readable recording medium such as a CD-ROM and a transmission medium such as the Internet.

### Advantageous Effects of Invention

With the present invention, it is possible to suppress a delay in communication resulting from processing of determining radiation pattern of an antenna.

### BRIEF DESCRIPTION OF DRAWINGS

FIG. 1 is a diagram illustrating an outline configuration of a wireless communication system according to an embodiment of the present invention.

FIG. 2 is a block diagram illustrating a detailed configuration of an adaptive array antenna device (transmission side) according to Embodiment 1 of the present invention.

FIG. 3 is a block diagram illustrating a detailed configuration of the adaptive array antenna device (receiving side) according to Embodiment 1 of the present invention.

FIG. 4 is a flow chart illustrating an operation of the adaptive array antenna device according to Embodiment 1 of the present invention.

FIG. 5 is a flow chart illustrating an operation of the adaptive array antenna device (transmission side) in a non-data transmission state according to Embodiment 1 of the present invention.

FIG. 6 is a flow chart illustrating an operation of the adaptive array antenna device (receiving side) in the non-data transmission state according to Embodiment 1 of the present invention.

FIG. 7 is a flow chart illustrating an operation of the adaptive array antenna device (transmission side) in a data transmission state according to Embodiment 1 of the present invention.

FIG. 8 is a flow chart illustrating an operation of the adaptive array antenna device (transmission side) in the non-data transmission state according to Embodiment 2 of the present invention.

FIG. 9 is a flow chart illustrating an operation of the adaptive array antenna device (transmission side) in the data transmission state according to Embodiment 2 of the present invention.

FIG. 10 is a flow chart illustrating an operation of the adaptive array antenna device (transmission side) in the data transmission state according to Embodiment 3 of the present invention.

FIG. 11 is a block diagram illustrating a configuration example of a conventional adaptive array antenna device.

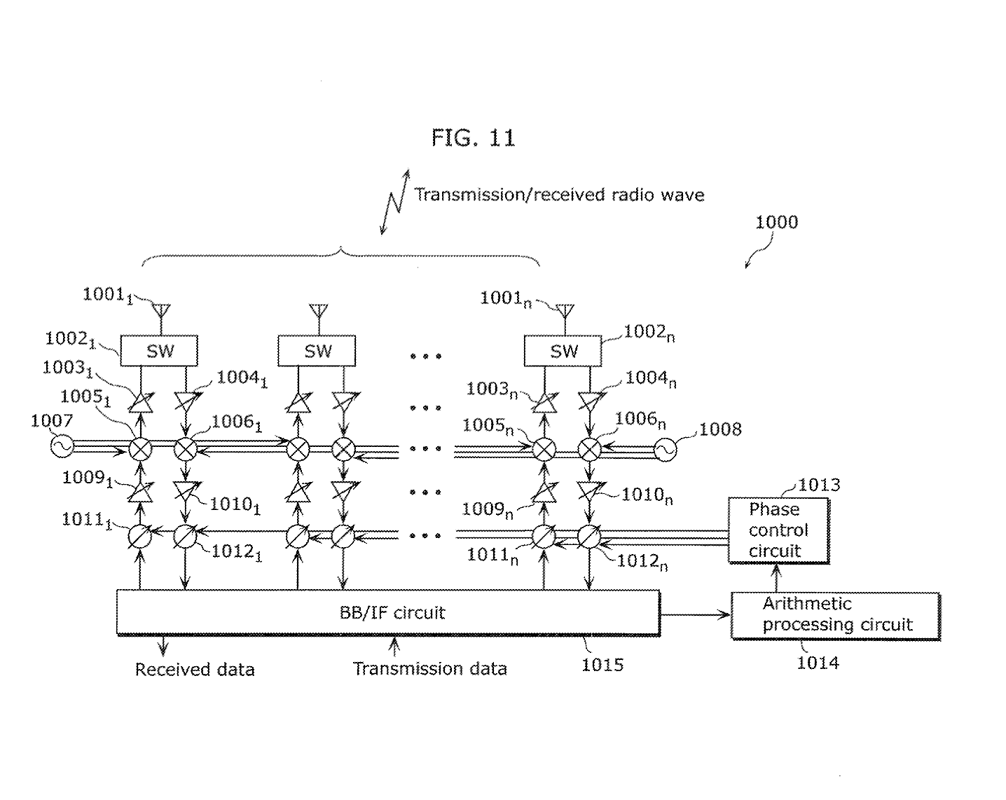

### DESCRIPTION OF EMBODIMENTS

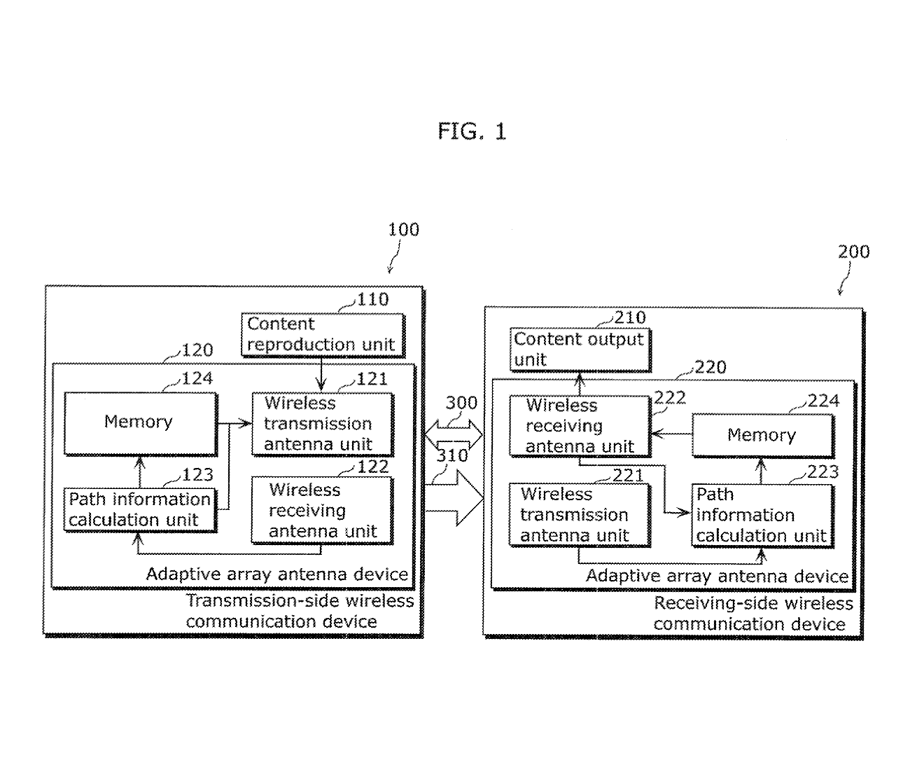

FIG. 1 is a diagram illustrating an outline configuration of a wireless communication system according to an embodiment of the present invention. First, an outline of a wireless communication system according to an embodiment of the present invention will be described with reference to FIG. 1.

The wireless communication system includes a transmission-side wireless communication device 100 and a receiving-side wireless communication device 200 wirelessly connected to each other, as shown in FIG. 1. The transmission-side wireless communication device 100 and the receiving-side wireless communication device 200 can perform wireless communication using a first wireless communication path 300 and a second wireless communication path 310.

Here, the first wireless communication path 300 is a communication path for performing transmission and receiving of control data mainly, which allows bidirectional communication. The first wireless communication path 300 uses a narrower band than that used by the second wireless communication path 310 (several MHz, for example), and thus the first wireless communication path 300 is unsuitable for transmission and receiving of data having a large size. Meanwhile, since the first wireless communication path 300 uses a radio wave with low directivity for performing communication, it is possible to perform communication even under an environment with low receiving sensitivity. It is to be noted that the control data is, for example, receipt acknowledgement data (ACK, typically) for notifying a partner of receipt of content data, test data used for searching processing for a transmission path, and so on.

On the other hand, the second wireless communication path 310 is a communication path for performing transmission of mainly control data, which allows only unidirectional communication (in the direction from the transmission-side wireless communication device 100 to the receiving-side wireless communication device 200 in the example shown in FIG. 1). Sine the second wireless communication path 310 uses a wider band than that used by the first wireless communication path 300 (several GHz, for example), and thus the second wireless communication path 310 is suitable for transmission of data having a large size (uncompressed image data, for example). Meanwhile, since the second wireless communication path 310 uses a radio wave with high directivity for performing communication, it is not possible to perform communication under an environment with low receiving sensitivity. This means that it is necessary to perform wireless communication while switching radiation pattern of a transmission radio wave according to a change in a radio wave transmission environment. It is to be noted that content data is, for example, uncompressed image data which is stream distributed.

The transmission-side wireless communication device 100 is a device which includes a content reproduction unit 110 and an adaptive array as antenna device 120 as shown in FIG. 1 and which wirelessly transmits content data to the receiving-side wireless communication device 200. In addition, the adaptive array antenna device 120 includes: a wireless transmission antenna unit 121; a wireless receiving antenna unit 122; a path information calculation unit 123; and a memory 124.

The content reproduction unit 110 reproduces content and outputs content data. The content to be reproduced may be recorded, for example, on a recording medium such as a hard disk drive (HDD), a blu-ray disc (BD), a digital versatile disc (DVD), and so on, or may be obtained through broadcasting or the like.

The wireless transmission antenna unit 121 transmits control data to the receiving-side wireless communication device (partner device) 200 through the first wireless communication path 300, and wirelessly transmits the content data to the receiving-side wireless communication device 200 through the second wireless communication path 310. The wireless receiving antenna unit 122 wirelessly receives control data from the receiving-side wireless communication device 200 through the first wireless communication path 300.

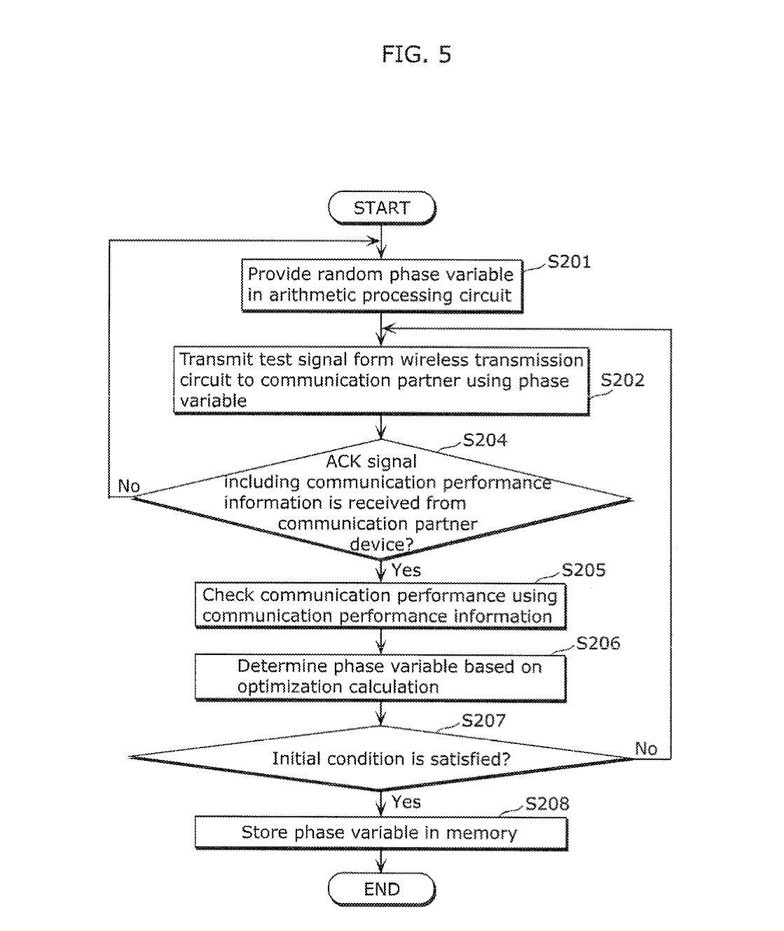

The path information calculation unit 123 calculates transmission path information for specifying radiation pattern of a radio wave emitted from the wireless transmission antenna unit 121. The processing of calculating the transmission path information will be described in detail with reference to FIG. 5.

It is to be noted here that a specific example of the transmission path information is not particularly limited. For example, in the case where the wireless transmission antenna unit 121 includes plural antenna elements and plural variable phase shifters that control the phase of a radio wave emitted from each of the antenna elements, the transmission path information may include a phase variable that is set in each of the variable phase shifters.

In the memory 124, the transmission path information calculated by the path information calculation unit 123 is stored. A specific configuration of the memory 124 is not particularly limited. Any means which are capable of recording data may be used, such as a dynamic random access memory (DRAM), a synchronous DRAM (SDRAM), a flash memory, a ferroelectric memory, and so on.

The receiving-side wireless communication device 200 is a device which includes a content output unit 210 and an adaptive array antenna device 220 as shown in FIG. 1 and which wirelessly receives the content data that is wirelessly transmitted from the transmission-side wireless communication device 100. In addition, the adaptive array antenna device 220 includes: a wireless transmission antenna unit 221; a wireless receiving antenna unit 222; a path information calculation unit 223; and a memory 224.

The content output unit 210 outputs the content data obtained from the transmission-side wireless communication device 100 and typically a display unit that displays image data. A specific configuration of the display unit is not particularly limited. For example, a liquid crystal display, a plasma display, an organic electro luminescence (EL) display, and so on may be used.

The wireless transmission antenna unit 221 transmits the control data to the transmission-side wireless communication device 100 through the first wireless communication path 300. The wireless receiving antenna unit 222 receives the control data from the transmission-side wireless communication device 100 through the first wireless communication path 300, and receives the content data from the transmission-side wireless communication device 100 through the second wireless communication path 310.

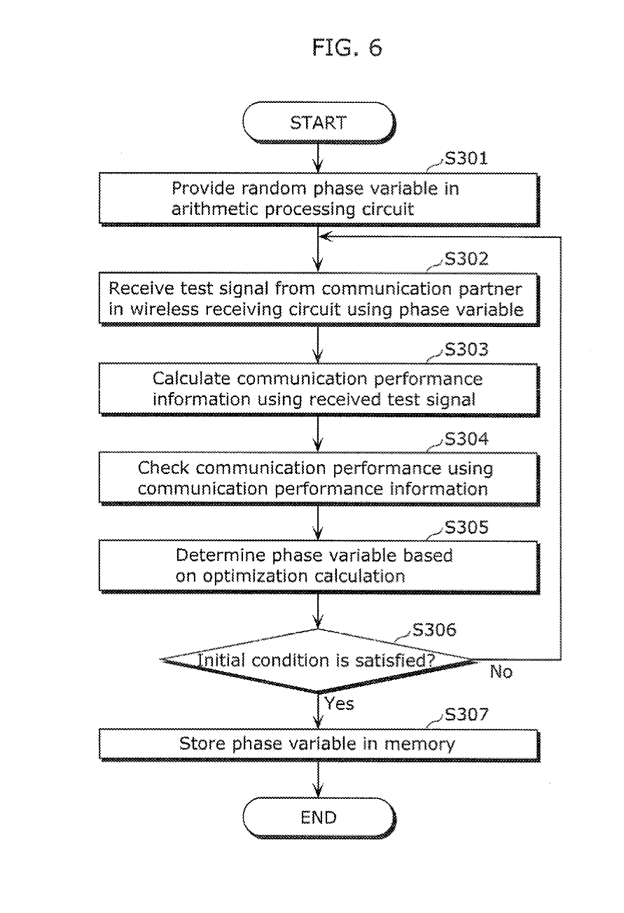

The path information calculation unit 223 calculates transmission path information for specifying radiation pattern of a radio wave emitted from the wireless receiving antenna unit 222. The processing of calculating the transmission path information will be described in detail with reference to FIG. 6.

It is to be noted here that a specific example of the transmission path information is not particularly limited. For example, in the case where the wireless receiving antenna unit 222 includes plural antenna elements and plural variable phase shifters that control the phase of a radio wave emitted from each of the antenna elements, the transmission path information may include a phase variable that is set in each of the variable phase shifters.

In the memory 224, the transmission path information calculated by the path information calculation unit 223 is stored. To be specific, the memory 224 may be the same as the memory 124.

### Embodiment 1

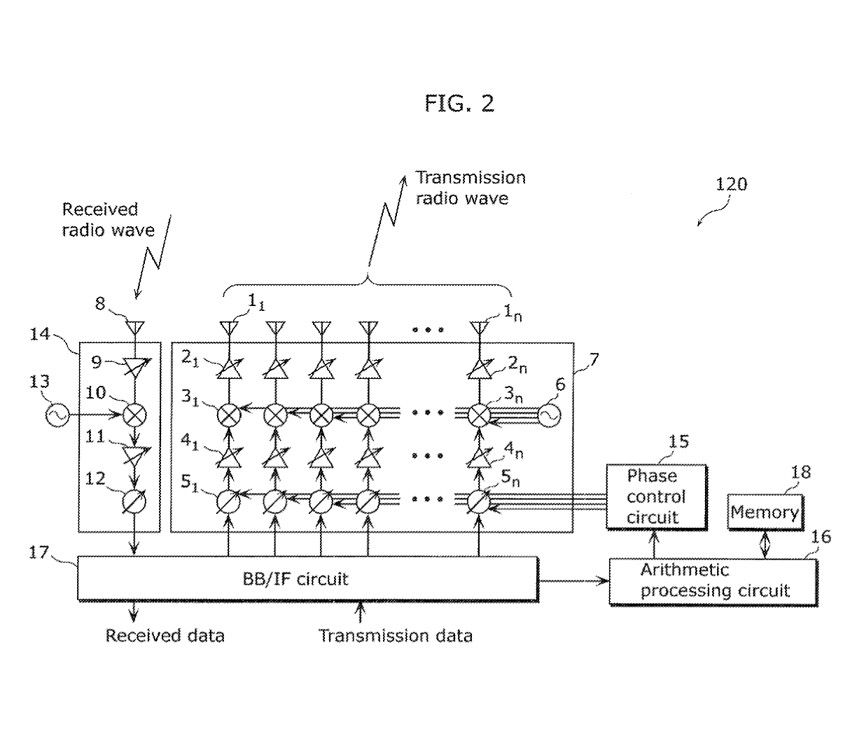

The following describes Embodiment 1 according to the present invention with reference to FIG. 2 to FIG. 7.

FIG. 2 is a block diagram illustrating a configuration example of the adaptive array antenna device 120 mounted on the transmission-side wireless communication device 100 according to Embodiment 1 of the present invention.

In FIG. 2, the adaptive array antenna device 120 includes: transmission antenna elements 1₁ to 1ₙ; a wireless transmission circuit 7; a receiving antenna element 8; a receiving local oscillator 13; a wireless receiving circuit 14; a phase control circuit 15; an arithmetic processing circuit 16; a BB/IF circuit 17; and a memory 18. In addition, the wireless transmission circuit 7 includes: transmission power amplifiers 2₁ to 2ₙ; transmission mixers 3₁ to 3ₙ; transmission driver amplifiers 4₁ to 4ₙ; transmission variable phase shifters 5₁ to 5ₙ; and a transmission local oscillator 6. In addition, the wireless receiving circuit 14 includes: a low noise amplifier 9; a receiving mixer as 10; a receiving driver amplifier 11; and a receiving variable phase shifter 12.

In the adaptive array antenna device 120 configured as above, for example, the transmission antenna elements 1₁ to 1ₙ and the wireless transmission circuit 7 shown in FIG. 2 correspond to the wireless transmission antenna unit 121 shown in FIG. 1, the receiving antenna element 8 and the wireless receiving circuit 14 shown in FIG. 2 correspond to the wireless receiving antenna unit 122 shown in FIG. 1, the phase control circuit 15, the arithmetic processing circuit 16, and the BB/IF circuit 17 shown in FIG. 2 correspond to the path information calculation unit 123 shown in FIG. 1, and the memory 18 corresponds to the memory 124 shown in FIG. 1.

It is to be noted that, the adaptive array antenna device 120 according to the present embodiment includes n transmission antennas and one receiving antenna as shown in FIG. 2; however, the number of the antennas is not limited to this.

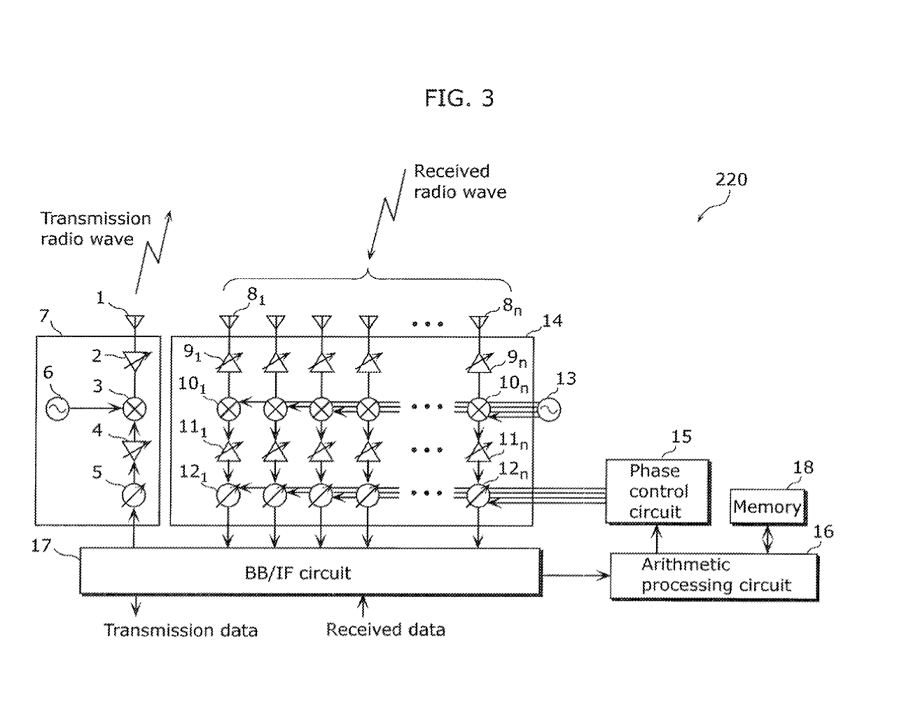

FIG. 3 is a block diagram illustrating a configuration example of the adaptive array antenna device 220 mounted on the receiving-side wireless communication device 200 according to Embodiment 1 of the present invention.

In FIG. 3, the adaptive array antenna device 220 includes: a transmission antenna element 1; a wireless transmission circuit 7; receiving antenna elements 8₁ to 8ₙ; a receiving local oscillator 13; a wireless receiving circuit 14; a phase control circuit 15; an arithmetic processing circuit 16; a BB/IF circuit 17; and a memory 18. In addition, the wireless transmission circuit 7 includes: a transmission power amplifier 2; a transmission mixer 3; a transmission driver amplifier 4; a transmission variable phase shifter 5; and a transmission local oscillator 6. In addition, the wireless receiving circuit 14 includes: low noise amplifiers 9₁ to 9ₙ; receiving mixers 10₁ to 10ₙ; receiving driver amplifiers 11₁ to 11ₙ; and receiving variable phase shifters 12₁ to 12ₙ.

In the adaptive array antenna device 220 configured as above, for example, the transmission antenna element 1 and the wireless transmission circuit 7 shown in FIG. 3 correspond to the wireless transmission antenna unit 221 shown in FIG. 1, the receiving antenna elements 8₁ to 8ₙ and the wireless receiving circuit 14 shown in FIG. 3 correspond to the wireless receiving antenna unit 222 shown in FIG. 1, the phase control circuit 15, the arithmetic processing circuit 16, and the BB/IF circuit 17 shown in FIG. 3 correspond to the path information calculation unit 223 shown in FIG. 1, and the memory 18 corresponds to the memory 224 shown in FIG. 1.

It is to be noted that, the adaptive array antenna device 220 according to the present embodiment includes one transmission antenna and n receiving antennas as shown in FIG. 3; however, the number of the antennas is not limited to this.

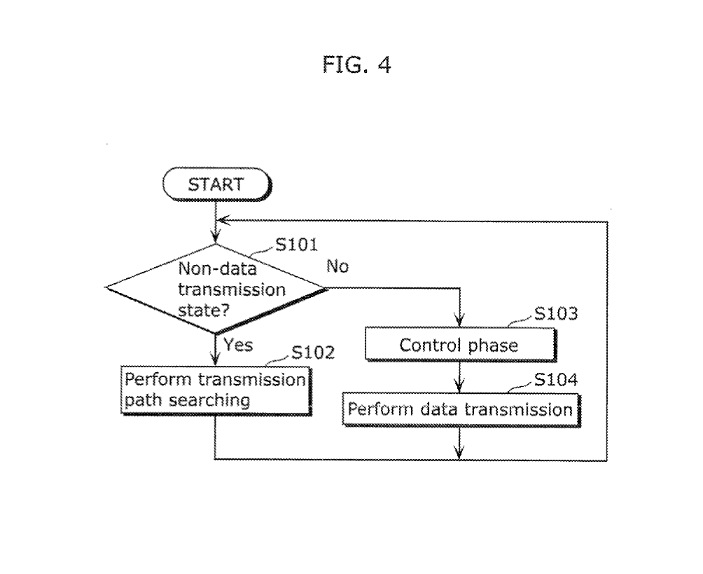

FIG. 4 is a flow chart illustrating an operation of the adaptive array antenna device 120 according to Embodiment 1 of the present invention. The following describes the operation of the adaptive array antenna device 120 according to Embodiment 1 with reference to FIG. 4. It is to be noted that, since the operation is also common to the adaptive array antenna device 220 on the receiving side, description is centered here on the operation of the adaptive array antenna device 120 on the transmission side.

In Step S101, the BB/IF circuit 17 determines whether or not the adaptive array antenna device 120 is in a non-data transmission state, and the operation proceeds to Step S102 when it is determined that the adaptive array antenna device 120 is in the non-data transmission state. In addition, when it is determined that the adaptive array antenna device 120 is not in the non-data transmission state, the operation proceeds to Step S103. Here, “non-data transmission state” indicates, for example, the case where wireless transmission of content data became available because of power activation of a connected communication partner device, or the like; however, the meaning is not limited to this.

More specifically, the “non-data transmission state” of the adaptive array antenna device 120 of the transmission side indicates, for example, the state before an instruction to transmit content data to the partner device (adaptive array antenna device 220) is issued. In addition, “instruction to transmit content data” includes, for example, detecting activation of the partner device (powered ON), pressing a button by a user for instructing starting reproduction of content, receiving, from the partner device, control data for requesting transmission of the content data, and so on.

On the other hand, the “non-data transmission state” of the adaptive array antenna device 220 of the receiving side indicates, for example, the state before an instruction to receive content data to be transmitted from the partner device (adaptive array antenna device 120) is issued. In addition, “instruction to receive content data” includes, for example, detecting activation of the partner device (powered ON), receiving control data notifying a start of transmission of the content data from the partner device, and so on.

In Step S102, the BB/IF circuit 17 performs transmission path searching processing and then the operation goes back to Step S101. The transmission path searching processing will be described in detail with reference to FIG. 5 and FIG. 6.

As described above, the adaptive array antenna device 120, before an instruction to transmit content data to the partner device is issued (non-data transmission state), calculates transmission path information for specifying radiation pattern with which the content data can be wirelessly transmitted to the partner device. Likewise, the adaptive array antenna device 220, before an instruction to receive content data transmitted from a partner device is issued (non-data transmission state), calculates transmission path information for specifying radiation pattern with which the content data can be wirelessly received from the partner device.

In Step S103, the BB/IF circuit 17 sets a phase variable on each of the transmission variable phase shifters 5₁ to 5ₙ using the arithmetic processing circuit 16 and the phase control circuit 15, and the operation proceeds to Step S104.

As described above, the adaptive array antenna device 120, when an instruction to transmit content data to the partner device is issued (data transmission state), starts transmission of the content data to the partner device using the radiation pattern specified by the transmission path information stored in the memory 18. Likewise, the adaptive array antenna device 220, when an instruction to receive content data to be transmitted from the partner device is issued (data transmission state), starts receiving the content data transmitted from the partner device using the radiation pattern specified by the transmission path information stored in the memory 18.

In Step S104, wireless transmission processing is performed on the content data. The BB/IF circuit 17 performs modulation processing and waveform shaping processing on the input transmission data, and outputs the processed data to the wireless transmission circuit 7 as n-system transmission data. The wireless transmission circuit 7 converts, to a radio frequency wave, each item of the n-system transmission data that is input from the BB/IF circuit 17, and transmits the converted data as a wireless radio wave from the n-system transmission antenna elements 1₁ to 1ₙ.

More specifically, each item of the n-system transmission data that is input from the BB/IF circuit 17 to the wireless transmission circuit 7 is converted to a wireless frequency using the transmission variable phase shifters 5₁ to 5ₙ, the transmission driver amplifiers 4₁ to 4ₙ, and the transmission mixers 3₁ to 3ₙ. Each item of the transmission data that is output from the transmission mixers 3₁ to 3ₙ is amplified by the transmission power amplifiers 2₁ to 2ₙ, and emitted as a wireless radio wave from the array antenna including the transmission antenna elements 1₁ to 1ₙ. When the wireless transmission processing on the content data ends, the operation goes back to Step S101.

The following describes in detail the operation (Step S 102) in the non-data transmission state with reference to FIG. 5 and FIG. 6

FIG. 5 is a flow chart illustrating an operation of the adaptive array antenna device 120 in the non-data transmission state according to the present embodiment.

In Step S201, the arithmetic processing circuit 16 reads, from the memory 18, initial phase variables which are randomly selected for the transmission variable phase shifters 5₁ to 5ₙ according to control of the BB/IF circuit 17 and provides the phase control circuit 15 with the read initial phase variables. The phase control circuit 15 sets, in the transmission variable phase shifters 5₁ to 5ₙ, the initial phase variables obtained from the arithmetic processing circuit 16, and the operation proceeds to Step S 202.

In Step S202, the BB/IF circuit 17 transmits n-system test data to the wireless transmission circuit 7. The n-system test data is emitted as an n-system wireless signal from the transmission antenna elements 1₁ to 1ₙ using the wireless transmission circuit 7. The operation performed by the wireless transmission circuit 7 will be described later. The operation proceeds to Step S204.

It is to be noted that the test data is transmitted through the first wireless communication path 300. However, wireless radio waves emitted from the transmission antenna elements 1₁ to 1ₙ are subjected to beam formation according to the initial phase variables set in each of the transmission variable phase shifters 5₁ to 5ₙ in the same manner as in the case of being transmitted through the second wireless communication path 310.

In Step S204, the BB/IF circuit 17 determines whether or not the ACK (Acknowledgement) signal that is an acknowledgement signal from the partner device which has received the test data in Step S202 is received by the wireless receiving circuit 14 using the receiving antenna element 8. The ACK signal includes communication performance information obtained from a receiving status of the partner device. Here, as the communication performance information, there is, for example, a received signal strength indication (RSSI), a packet error rate (PER), and the like.

The BB/IF circuit 17 determines that the ACK signal is received when the ACK signal is output from the wireless receiving circuit 14, and the operation proceeds to Step S205. On the other hand, the BB/IF circuit 17 determines that the ACK signal is not received when the ACK signal is not output from the wireless receiving circuit 14, and the operation goes back to Step S201.

In Step S205, the BB/IF circuit 17 obtains communication performance information included in the obtained ACK signal. The BB/IF circuit 17 checks the communication performance with the current phase variable using the obtained communication performance information.

In Step S206, the arithmetic processing circuit 16 performs optimization calculation using n initial phase variables as parameters and optimization calculation using the obtained communication performance information, thereby determining n phase variables suitable for wireless communication of content data. Then the operation proceeds to Step S207. Here, n phase variables are values corresponding to the respective transmission variable phase shifters 5₁ to 5ₙ. In addition, the optimization calculation is not a subject matter of the present invention, and thus any method may be used for carrying out the optimization calculation. For example, the method of steepest descent, the method of minimizing mean square error, and the like can be used.

In Step S207, whether or not an initial setting condition of the optimization technique is satisfied, through a loop of the above-described optimization technique is determined. When it is determined that the initial condition is satisfied, the operation proceeds to Step S208. When it is determined that the initial condition is not satisfied, the operation goes back to Step S202. It is to be noted that the initial condition refers, for example, to a case where the result of optimization calculation exceeds a predetermined threshold.

In Step S208, the arithmetic processing circuit 16 stores, in the memory 18, the n phase variables determined in Step S206 as transmission path information that indicates one transmission path.

FIG. 6 is a flow chart illustrating an operation of the adaptive array antenna device 220 in the non-data transmission state according to the present embodiment. It is to be noted that detailed explanation for the points common to FIG. 5 is omitted, and the following description is centered on the differences.

In Step S301, the arithmetic processing circuit 16 sets random initial phase variables in the receiving variable phase shifters 12₁ to 12ₙ using the phase control circuit 15, and the operation proceeds to Step S302. In Step S302, the BB/IF circuit 17 receives, using the wireless receiving circuit 14, the test data transmitted from the partner device. In Step S303, the BB/IF circuit 17 calculates communication performance information based on the received test data.

Each of the processes in Step S304 to Step S307 are the same as a corresponding one of the processes in Step S204 to Step S207, and thus the description for them will be omitted. It is to be noted that the adaptive array antenna device 220, when the initial condition is not satisfied in Step S306, transmits, to the partner device, an ACK signal including information for requesting retransmission of the test signal.

As described above, each of the adaptive array antenna devices 120 and 220 calculates a phase variable suitable for wireless communication. However, when the transmission side and the receiving side concurrently perform the processes described above, an appropriate phase variable cannot be calculated. In view of the above, while the adaptive array antenna device 120 on the transmission side performs the processes shown in FIG. 5, the adaptive array antenna device 220 on the receiving side does not change the phase variable. Likewise, while the adaptive array antenna device 220 on the receiving side performs the processes shown in FIG. 6, the adaptive array antenna device 120 on the transmission side does not change the phase variable.

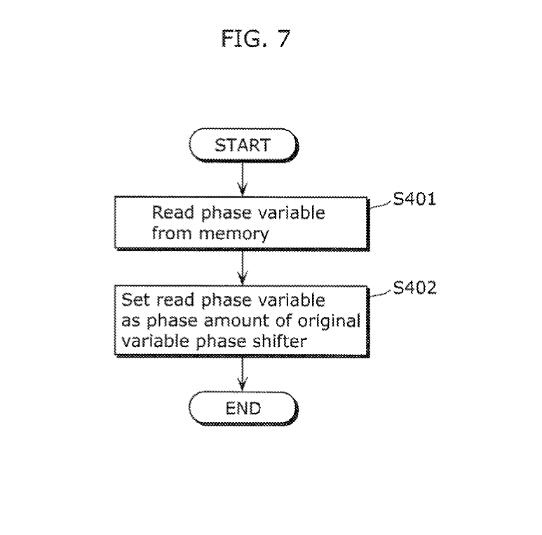

Next, the phase control in Step S103 shown in FIG. 4 will be described with reference to FIG. 7. It is to be noted that subsequent processes will be described centering on the operation performed by the adaptive array antenna device 120 because the processes are substantially the same and the only difference is that whether the processes are performed on the wireless transmission circuit 7 by the adaptive array antenna device 120 on the transmission side or performed on the wireless transmission circuit 14 by the adaptive array antenna device 220 on the receiving side.

FIG. 7 is a flow chart illustrating an operation of the adaptive array antenna device 120 in a data transmission state. The processes shown in FIG. 7 are performed, for example, with the timing that the instruction to transmit content data is issued.

In Step S401, the arithmetic processing circuit 16 reads the transmission path information stored in the memory 18 according to the control of the BB/IF circuit 17 and outputs n phase variables included in the transmission path information to the phase control circuit 15, and the operation proceeds to Step S402.

In Step S402, the phase control circuit 15 sets the n phase variables obtained from the arithmetic processing circuit 16 in each of the transmission variable phase shifters 5₁ to 5ₙ. This makes the array antenna in a phase state suitable to wireless transmission determined in the non-data transmission state; that is, a state in which the array antenna can transmit wireless radio waves of the radiation pattern suitable to wirelessly transmitting content data.

As to receiving, the received radio waves received by the receiving antenna element 8 are amplified by the low noise amplifier 9, converted into intermediate frequency by the receiving mixer 10, and output by the BB/IF circuit 17 using the receiving driver amplifier 11 and the receiving variable phase shifter 12. The BB/IF circuit 17 performs signal processing and demodulation processing on the data output from the wireless receiving circuit 14 and then outputs the data as received data.

In the present embodiment, since the optimization calculation is carried out in the non-data transmission state and the transmission path information is stored in the memory 18, it is not necessary to perform the optimization calculation in the data transmission state. Therefore, the adaptive array antenna device 120 on the transmission side can instantly set the radiation pattern suitable to wirelessly transmitting content data in the transmission antenna element 1₁ to 1ₙ. In addition, it is only necessary for the adaptive array antenna device 120 on the transmission side to obtain an ACK signal, and thus the wireless receiving circuit 14 having a large number of systems is not required. Thus, separating the wireless transmission circuit 7 and the wireless receiving circuit 14 into different systems eliminates the need to provide the selector switch for transmission and receiving immediately under the transmission antenna elements 1₁ to 1ₙ.

As described above, in the present embodiment, the phase variable that is set in the transmission variable phase shifters 5₁ to 5ₙ when transmitting content data is calculated in the non-data transmission state, thereby allowing instantly determining the phase variable suitable to the wireless transmission of the content data; that is, the transmission path.

Likewise, the adaptive array antenna device 220 on the receiving side can instantly set the radiation pattern suitable to wirelessly receiving content data in the transmission antenna element 8₁ to 8ₙ. In addition, it is only necessary for the adaptive array antenna device 220 on the receiving side to transmit the ACK signal, and thus the wireless transmission circuit 7 having a large number of systems is not required. Thus, separating the wireless transmission circuit 7 and the wireless receiving circuit 14 into different systems eliminates the need to provide the selector switch for transmission and receiving immediately under the receiving antenna elements 8₁ to 8ₙ.

As described above, in the present embodiment, the phase variable that is set in the receiving variable phase shifters 12₁ to 12ₙ when receiving content data is calculated in the non-data transmission state, thereby allowing instantly determining the phase variable suitable to the wireless receiving of the content data; that is, the transmission path.

### Embodiment 2

There is a case where a communication status deteriorates due to a change in the surrounding radio wave transmission environment while performing wireless transmission of content data. For example, when communication is carried out using radio waves having significantly high frequency, such as millimeter waves, there is a case where the radio waves are blocked to the extent that the communication is disabled due to blockage by a person or the like.

In view of the above, in the present embodiment, an adaptive array antenna device 120 will be described which adapts to change in a surrounding radio wave transmission environment by sweeping an initial value of optimization calculation in a possible range for a phase variable, for example, and performing the optimization calculation plural times to prepare in advance plural items of transmission path information. It is to be noted that, since the adaptive array antenna device 120 according to the present embodiment is the same as that shown in FIG. 2 except that the specific operation performed by the arithmetic processing circuit 16 is different, a detailed explanation for the same parts is omitted and the description is focused on the differences.

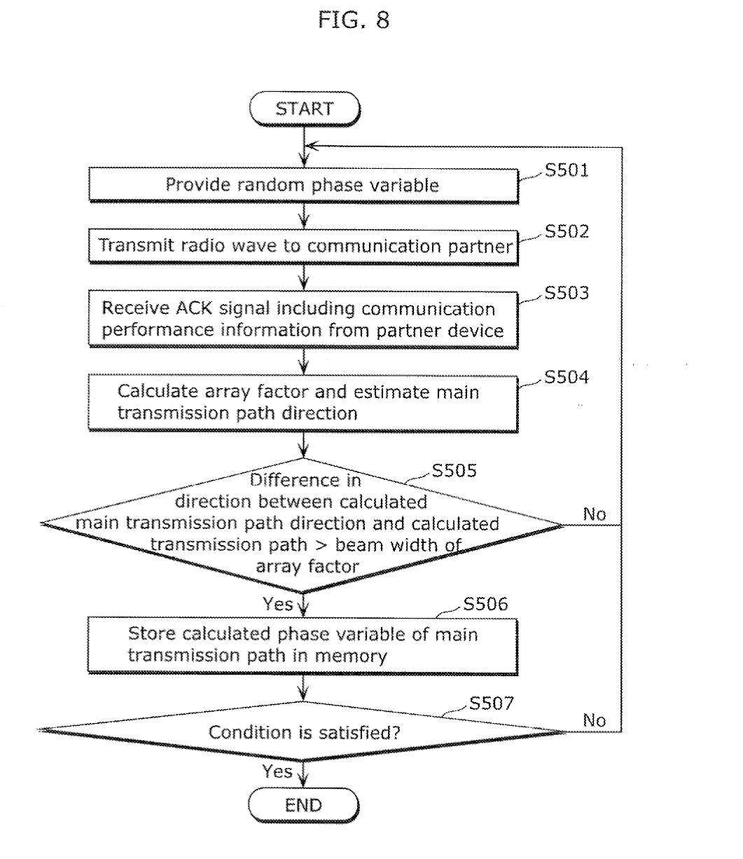

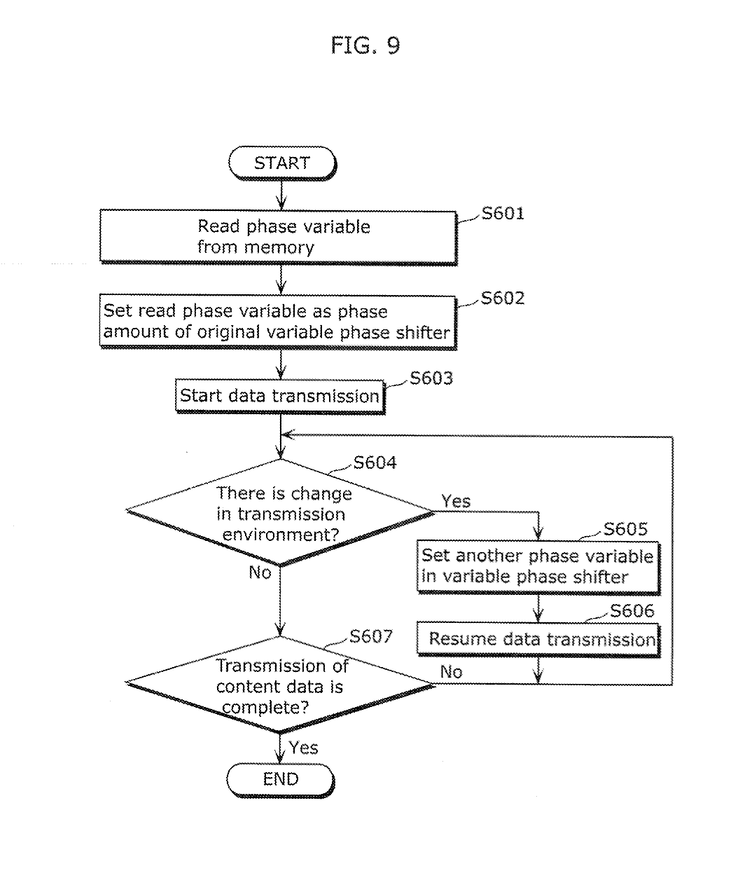

The following describes Embodiment 2 according to the present invention with reference to FIG. 8 and FIG. 9.

FIG. 8 is a flow chart illustrating an operation of the adaptive array antenna device 120 in the non-data transmission state according to the present embodiment.

In Step S501, the arithmetic processing circuit 16 sets random initial phase variables in the transmission variable phase shifters 5₁ to 5ₙ using the phase control circuit 15 according to control of the BB/IF circuit 17, and the operation proceeds to Step S502.

In Step S502, the BB/IF circuit 17 wirelessly transmits a test signal to a partner device using the wireless transmission circuit 7 and the transmission antenna elements 1₁ to 1ₙ, and the operation proceeds to Step S503.

In Step S503, the BB/IF circuit 17 receives, from the partner device, an ACK signal in which communication performance information is stored, using the receiving antenna element 8 and the wireless receiving circuit 14, and then the operation proceeds to Step S504.

In Step S504, the BB/IF circuit 17 outputs, to the arithmetic processing circuit 16, the communication performance information included in the ACK signal. The arithmetic processing circuit 16 calculates an array factor using the communication performance information output from the BB/IF circuit 17. The calculation of the array factor is performed when a set of phase variables is obtained by optimization calculation from initial values so as to compare with other sets of phase variables to make transmission paths substantially different from one another.

More specifically, the array factor is calculated based on the obtained phase variable by the arithmetic processing circuit 16. An array factor AF (θ, φ) can be calculated by a calculation formula as shown in Expression 1, for example.

$$\begin{matrix}Expression 1 & \\ AF ( θ , φ ) = {\sum }_{n = 1}^{N} exp ( j {α}_{n} ) \cdot exp \{ jβ ( {x}_{n} sin θcosφ + {y}_{n} sin θsinφ ) \} & [ Math . 1 ]\end{matrix}$$

In Expression 1, θ denotes an angle in the azimuth direction, φ denotes an angle in the elevation direction, αₙ denotes a phase of the n-th variable phase shifter, β denotes a propagation coefficient, xₙ denotes a position of the n-th antenna (x coordinate), yₙ denotes a position of the n-th antenna (y coordinate), and N denotes the largest value in the n systems.

The direction of a main beam can be obtained by calculating θₘₐₓ and φₘₐₓ with which AF is the largest using the calculation result of Expression 1, thereby allowing estimation of a main transmission path.

In Step S505, the arithmetic processing circuit 16 compares the result of calculating the main transmission path with the main transmission path obtained when using the phase variable which is already stored in the memory 18. When the difference between the two main transmission paths (beam direction) does not exceed a beam width of the array factor, there is a high possibility that the two main transmission paths are the same. Thus, it is determined that storage is not required and the operation goes back to Step S501 to perform calculation again with a different condition. On the other hand, when the difference between the two main transmission paths exceeds a beam width of the array factor, there is a high possibility that the two main transmission paths are different transmission paths, and thus the operation proceeds to Step S506.

In Step S506, the arithmetic processing circuit 16 stores, in the memory 18, the initial phase variable at this time as transmission path information.

In Step S507, the arithmetic processing circuit 16 repeatedly performs the above-described calculation until the calculation conditions (a memory storage amount, a necessary storage amount, an initial phase added amount, and the like) are satisfied, while changing the initial phase variable of the optimization calculation.

FIG. 9 is a flow chart illustrating an operation of the adaptive array antenna device 120 in the data transmission state.

In Step S601, the arithmetic processing circuit 16, when turning into data transmission state, reads the transmission path information from the memory 18 and provides the phase control circuit 15 with n phase variables included in the read transmission path information, and the operation proceeds to Step S602.

In Step S602, the phase control circuit 15 determines the radiation pattern of a transmission radio wave emitted form the array antenna, by providing the transmission variable phase shifters 5₁ to 5ₙ with the n phase variables obtained from the arithmetic processing circuit 16, and the operation proceeds to Step S603.

In Step S603, transmission of content data is started in response to the control performed by the BB/IF circuit 17.

In Step S604, the BB/IF circuit 17 determines the communication status using the ACK signal which the wireless receiving circuit 14 receives from the communication partner, and stops temporarily the transmission of content data when it is determined that there is a change in the radio wave transmission environment, and the operation proceeds to Step S605. On the other hand, when it is determined that there is no change in the radio wave transmission environment, the operation proceeds to Step S607.

In Step S605, the arithmetic processing circuit 16 reads another item of the transmission path information from the memory 18 in response to the control performed by the BB/IF circuit 17 and provides the transmission variable phase shifters 5₁ to 5ₙ with the n phase variables included in the read transmission path information, via the phase control circuit 15, to change the transmission path, and the operation proceeds to Step S606. The reading of another item of the transmission path information is carried out by changing a read address for the memory 18, for example.

In Step S606, the BB/IF circuit 17 resumes transmission of content data, and the operation goes back to Step S604.

In Step S607, the BB/IF circuit 17 goes back to the process of Step S604 when it is determined that the transmission of content data is not completed. On the other hand, when it is determined that the transmission of content data is completed, the operation is completed.

According to the present embodiment as described above, since plural items of the transmission path information which are the results of optimization calculation are stored in the memory 18, it is possible to instantly change the radiation pattern of the array antenna in response even to an instant change in the radio wave transmission environment due to blockage or the like, thereby allowing prevention of communication interruption and the like.

It is to be noted that, the condition of storage into the memory 18 is explained as taking the beam width as an example; however, other conditions may be used.

### Embodiment 3

Even when wireless communication is carried out by sequentially reading plural items of transmission path information stored in the memory 18 in advance and changing the transmission path in response to a change in the radio wave transmission environment as described in Embodiment 2, there is a high possibility that the communication cannot be carried out using any items of transmission path information stored in the memory 18 in such a case where the location of the wireless communication device is changed.

In view of the above, the adaptive array antenna device 120 will be described in the present embodiment, which can respond to the case where the location of the wireless communication device is changed. It is to be noted that, since the adaptive array antenna device 120 according to the present embodiment is the same as that shown in FIG. 2 except that the specific operation performed by the arithmetic processing circuit 16 is different, a detailed explanation for the same parts is omitted and the description is focused on the differences.

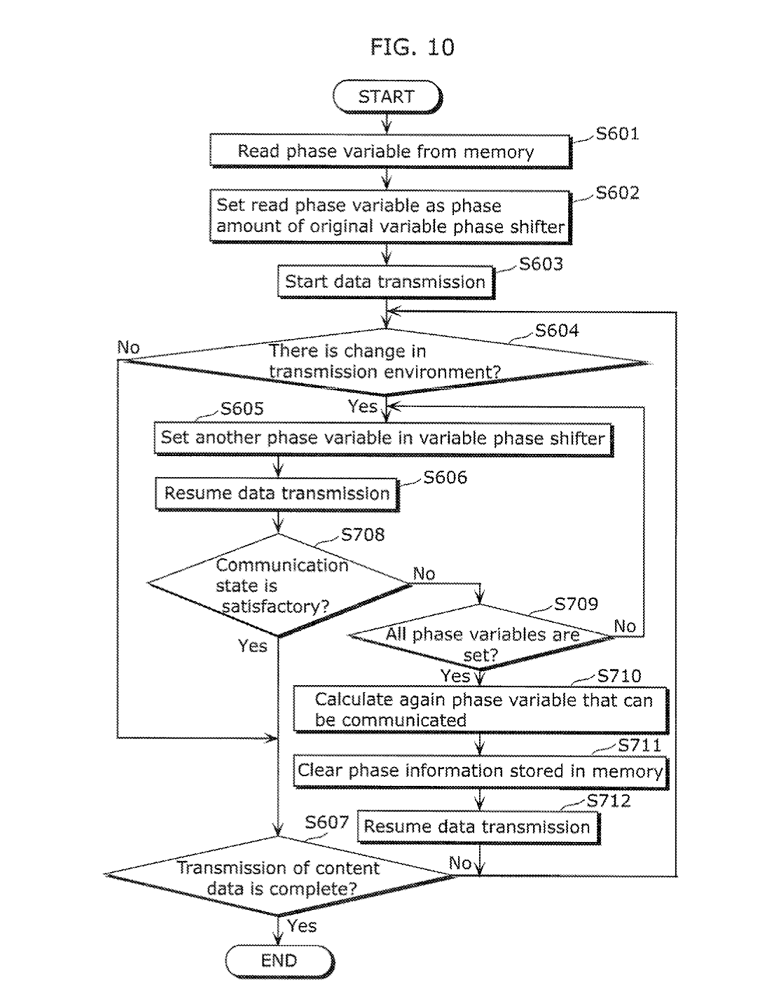

FIG. 10 is a flow chart illustrating an operation of the adaptive array antenna device 120 in the data transmission state according to the present embodiment. The same reference numerals are provided to the same steps as the steps in Embodiment 2 to omit descriptions for the same steps.

In Step S708, the BB/IF circuit 17 determines whether or not the wireless communication state (radio wave transmission environment) is satisfactory. When it is determined that the wireless communication state is satisfactory, the operation proceeds to Step S712. On the other hand, when it is determined that the wireless communication state is not satisfactory, the operation proceeds to Step S709.

In Step S709, the BB/IF circuit 17 uses the phase control circuit 15 to determine whether or not all of the items of transmission path information stored in the memory 18 are set in the transmission variable phase shifters 5₁ to 5ₙ. When there remains an item of transmission path information which is not set yet, the operation goes back to Step S605 to set the item of transmission path information which is not set yet. On the other hand, when all of the items of transmission path information are set, the operation proceeds to Step S710.

In Step S710, when it is determined that the wireless communication state does not improve even when all of the items of transmission path information stored in the memory 18 is read, the BB/IF circuit 17 causes the arithmetic processing circuit 16 to perform the optimization calculation again. The arithmetic processing circuit 16 calculates a new item of transmission path capable of communication, and the operation proceeds to Step S711. More specifically, the arithmetic processing circuit 16 performs the processes shown in FIG. 5.

In Step S711, the BB/IF circuit 17 clears all of the items of transmission path information stored in the memory 18, and the operation proceeds to Step S712.

In Step S712, the BB/IF circuit 17 sets n phase variables included in the newly calculated item of transmission path information, in the transmission variable phase shifters 5₁ to 5ₙ, and resumes wireless transmission of content data.

The BB/IF circuit 17, upon entering the non-data transmission state next time, calculates again the transmission path information, using the arithmetic processing circuit 16, with the technique described in Embodiment 2, and stores the calculated transmission path information into the memory 18 again.

According to the present embodiment as described above, it is possible to calculate again the transmission path information and store again into the memory 18, even when the location of the wireless device is changed.

### Other Embodiments

It is to be noted that, although the present invention has been described according to the above-mentioned embodiments, it is apparent that the present invention is not limited to the above-mentioned embodiments. The below cases may also be included in the present invention.

Each device mentioned above is, to be specific, a computer system that includes a microprocessor, a ROM, a RAM, a hard disk unit, a display unit, a keyboard, a mouse, and so on. A computer program is stored on the RAM or the hard disk unit. The microprocessor operates according to the computer program, so that each device achieves its function. Here, the computer program is configured by combining plural instruction codes indicating instructions for a computer in order to implement a predetermined function.

A part or all of the constituent elements constituting the respective apparatuses may be configured from a single System-LSI (Large-Scale Integration). The System-LSI is a super-multi-function LSI manufactured by integrating constituent units on one chip, and is specifically a computer system configured by including a microprocessor, a ROM, a RAM, and so on. A computer program is stored in the RAM. The System-LSI achieves its function through the microprocessor's operation according to the computer program.

A part or all of the constituent elements constituting the respective apparatuses may be configured as an IC card which can be attached and detached from the respective apparatuses or as a stand-alone module. The IC card or the module is a computer system configured from a microprocessor, a ROM, a RAM, and so on. The IC card or the module may also include the aforementioned super-multi-function LSI. The IC card or the module achieves its function through the microprocessor's operation according to the computer program. The IC card or the module may also be implemented to be tamper-resistant.

The present invention may be a method as described above. In addition, the present invention, may be a computer program for realizing the previously illustrated method, using a computer, and may also be a digital signal including the computer program.

Furthermore, the present invention may also be realized by storing the computer program or the digital signal in a computer readable recording medium such as flexible disc, a hard disk, a CD-ROM, an MO, a DVD, a DVD-ROM, a DVD-RAM, a BD (Blu-ray Disc), and a semiconductor memory. Furthermore, the present invention also includes the digital signal recorded in these recording media.

Furthermore, the present invention may also be realized by the transmission of the aforementioned computer program or digital signal via a telecommunication line, a wireless or wired communication line, a network represented by the Internet, a data broadcast and so on.

The present invention may also be a computer system including a microprocessor and a memory, in which the memory stores the aforementioned computer program and the microprocessor operates according to the computer program.

>Furthermore, by transferring the program or the digital signal by recording onto the aforementioned recording media, or by transferring the program or digital signal via the aforementioned network and the like, execution using another independent computer system is also made possible.

Each of the above-mentioned embodiments may be applied to each of the above-described and modifications.

The embodiments according to the present invention have been described with reference to the drawings; however, the present invention is not limited to the illustrated embodiments. Various changes and modifications may be applied to the embodiments as shown above, unless such changes and modifications depart from the same or equivalent scope of the present invention.

### INDUSTRIAL APPLICABILITY

The wireless transmission device according to the present invention is usefully used in the field of radio-frequency wave communication.

### REFERENCE SIGNS LIST

1, 1₁ to 1ₙ transmission antenna element
2, 2₁ to 2ₙ, 1003ₖ power amplifier
3, 3₁ to 3ₙ, 1005ₖ transmission mixer
4, 4₁ to 4ₙ, 1009ₖ transmission driver amplifier
5, 5₁ to 5ₙ, 1011ₖ transmission variable phase shifter
6, 1007 transmission local oscillator
7 wireless transmission circuit
8, 8₁ to 8ₙ receiving antenna element
9, 9₁ to 9ₙ, 1004ₖ low noise amplifier
10, 10₁ to 10ₙ, 1006ₖ receiving mixer
11, 11₁ to 11ₙ, 1010ₖ receiving driver amplifier
12, 12₁ to 12ₙ, 1012ₖ receiving variable phase shifter
13, 1008 receiving local oscillator
14 wireless receiving circuit
15, 1013 phase control circuit
16, 1014 arithmetic processing circuit
17, 1015 BB/IF circuit
18 memory
100 transmission-side wireless communication device
200 receiving-side wireless communication device
110 content reproduction unit
120, 220, 1000 adaptive array antenna device
121, 221 wireless transmission antenna unit
122, 222 wireless receiving antenna unit
123, 223 path information calculation unit
124, 224 memory
210 content output unit
300 first wireless communication path
310 second wireless communication path
1001ₖ antenna element
1002ₖ selector switch

1. An adaptive array antenna device which wirelessly transmits content data to a partner device, said adaptive array antenna device comprising:
a wireless transmission antenna unit configured to wirelessly transmit the content data to the partner device;
a wireless receiving antenna unit configured to receive control data indicating a receipt state of the content data of the partner device,
a path information calculation unit configured to calculate transmission path information for specifying radiation pattern with which the content data can be wirelessly transmitted to the partner device, before an instruction to transmit the content data to the partner device is issued; and
a memory in which the transmission path information calculated by said path information calculation unit is stored,
wherein said wireless transmission antenna unit is configured to start transmitting the content data to the partner device using the radiation pattern specified by the transmission path information stored in said memory, when the instruction to transmit the content data to the partner device is issued,
and when the receipt state indicated by the control data received by said wireless receiving antenna unit falls below a predetermined threshold,
said path information calculation unit is configured to calculate a new item of transmission path information that is different from the transmission path information stored in said memory, and
said wireless transmission antenna unit is configured to resume transmission of the content data to the partner device using radiation pattern specified by the new item of the transmission path information calculated by said path information calculation unit.

2. The adaptive array antenna device according to claim 1,
wherein said path information calculation unit is configured to calculate items of the transmission path information in advance, and to store the calculated items of the transmission path information in said memory, and
said wireless transmission antenna unit is configured to select one of the items of the transmission path information stored in said memory, and to transmit the content data to the partner device using the radiation pattern specified by the selected item of the transmission path information.

3. The adaptive array antenna device according to claim 2,
wherein said path information calculation unit is configured to calculate the items of the transmission path information which indicate transmission paths to the partner device substantially different from each other, and to store the calculated items of the transmission path information in said memory.

4. The adaptive array antenna device according to claim 2, further comprising
a wireless receiving antenna unit configured to receive control data indicating a receipt state of the content data of the partner device,
wherein, when the receipt state indicated by the control data received by said wireless receiving antenna unit falls below a predetermined threshold, said wireless transmission antenna unit is configured to select an other one of the items of the transmission path information stored in said memory, and to resume transmission of the content data to the partner device using radiation pattern specified by the other one of the items of the transmission path information which has been selected.

5. (canceled)

6. The adaptive array antenna device according to claim 2,
wherein a priority level of each of the items of the transmission path information is stored in said memory, and
said wireless transmission antenna unit is configured to select the items of the transmission path information in a descending order of the priority level.

7. The adaptive array antenna device according to claim 1,
wherein said wireless transmission antenna unit includes: antenna elements; and variable phase shifters each of which controls a phase of a radio wave emitted from a corresponding one of said antenna elements, and
said path information calculation unit is configured to calculate, as the transmission path information, phase variables each of which is set in a corresponding one of said variable phase shifters.

8. The adaptive array antenna device according to claim 7,
wherein said path information calculation unit is configured to transmit test data to the partner device with each of said variable phase shifters having a corresponding one of the phase variables determined arbitrarily, to calculate each of the phase variables of said variable phase shifters through a predetermined optimization calculation technique using, as a parameter, communication performance indicated in response data to the test data, and to store the calculated phase variables in said memory.

9. The adaptive array antenna device according to claim 7,
wherein said path information calculation unit is configured to transmit test data to the partner device with each of said variable phase shifters having a corresponding one of the phase variables determined arbitrarily, and to store the phase variables determined arbitrarily in said memory, when communication performance indicated in response data to the test data exceeds a predetermined threshold.

10. The adaptive array antenna device according to claim 8,
wherein said wireless transmission antenna unit is configured to wirelessly transmit the test data to the partner device using a first wireless communication path, and to wirelessly transmit the content data to the partner device using a second wireless communication path which has a band wider than a band of the first wireless communication path and requires receiving sensitivity higher than receiving sensitivity of the first wireless communication path.

11. An adaptive array antenna device which wirelessly receives content data from a partner device, said adaptive array antenna device comprising:
a wireless receiving antenna unit configured to wirelessly receive the content data from the partner device;
a path information calculation unit configured to calculate transmission path information for specifying radiation pattern with which the content data can be wirelessly received from the partner device, before an instruction to receive the content data transmitted from the partner device is issued; and
a memory in which the transmission path information calculated by said path information calculation unit is stored,
wherein said wireless receiving antenna unit is configured to start receiving the content data transmitted from the partner device using the radiation pattern specified by the transmission path information stored in said memory, when the instruction to receive the content data transmitted from the partner device is issued,
and when a receipt state of the content data received by said wireless receiving antenna unit falls below a predetermined threshold,
said path information calculation unit is configured to calculate a new item of transmission path information that is different from the transmission path information stored in said memory, and
said wireless receiving antenna unit is configured to resume receiving of the content data transmitted from the partner device using radiation pattern specified by the new item of the transmission path information calculated by said path information calculation unit.

12. An antenna control method performed by an adaptive array antenna device which wirelessly transmits content data to a partner device and includes a memory, a wireless receiving antenna unit which receives control data indicating a receipt state of the content data of the partner device, and a wireless transmission antenna unit for wirelessly transmitting the content data to the partner device,
said antenna control method comprising:
calculating transmission path information for specifying radiation pattern with which the content data can be wirelessly transmitted to the partner device and storing the transmission path information in the memory, before an instruction to transmit the content data to the partner device is issued; and
causing the wireless transmission antenna unit to start transmitting the content data to the partner device using the radiation pattern specified by the transmission path information stored in the memory, when the instruction to transmit the content data to the partner device is issued,
wherein, when the receipt state indicated by the control data received by the wireless receiving antenna unit falls below a predetermined threshold,
in said calculating, a new item of transmission path information that is different from the transmission path information stored in the memory is further calculated, and
in said causing, the wireless transmission antenna unit is further caused to resume transmitting of the content data to the partner device using radiation pattern specified by the new item of the transmission path information calculated in said calculating.

13. An antenna control method performed by an adaptive array antenna device which wirelessly receives content data from a partner device and includes a memory and a wireless receiving antenna unit for wirelessly receiving the content data from the partner device, said antenna control method comprising:
calculating transmission path information for specifying radiation pattern with which the content data can be wirelessly received from the partner device, before an instruction to receive the content data transmitted from the partner device is issued; and
causing the wireless receiving antenna unit to start receiving the content data transmitted from the partner device using the radiation pattern specified by the transmission path information stored in the memory, when the instruction to receive the content data transmitted from the partner device is issued,
wherein, when a receipt state of the content data received by the wireless receiving antenna unit falls below a predetermined threshold,
in said calculating, a new item of transmission path information that is different from the transmission path information stored in the memory is further calculated, and
in said causing, the wireless receiving antenna unit is further caused to resume receiving of the content data transmitted from the partner device using radiation pattern specified by the new item of the transmission path information calculated in said calculating.

14. The adaptive array antenna device according to claim 1,
wherein said path information calculation unit is configured to calculate the new item of transmission path information that is substantially different from any of items of transmission path information stored in said memory, by comparing shapes of radiation patterns of the items of transmission path information, and to store the calculated new item of the transmission path information in said memory.

15. The adaptive array antenna device according to claim 1,
wherein, when the receipt state indicated by control data received by the wireless receiving antenna unit falls below a predetermined threshold, said path information calculation unit is further configured to delete items of transmission path information stored in said memory, and to store the new item of the transmission path information in said memory.
